(19) United States
(12) Patent Application Publication
(10) Pub. No.: US 2010/0045589 A1
(43) Pub. Date: Feb. 25, 2010

(54) DISPLAY DEVICE HAVING FIELD EMISSION UNIT WITH BLACK MATRIX

(75) Inventors: James Francis Edwards, Lancaster, PA (US); Peter Michael Ritt, East Petersburg, PA (US); David Paul Ciampa, Lancaster, PA (US)

Correspondence Address: Robert D. Shedd, Patent Operations;THOMSON Licensing LLC, P.O. Box 5312, Princeton, NJ, 08543-5312, US

(73) Assignee: THOMSON LICENSING LLC, Princeton, NJ (US)

(21) Appl. No.: 12/448,297

(22) PCT Filed: Dec. 5, 2007
(86) PCT No.: PCT/US2006/048145

§ 371 Date: Jun. 16, 2009

(51) Int. Cl. G09G 3/36

(52) U.S. Cl. 345/102

(57) ABSTRACT

A liquid crystal display includes a liquid crystal display front end component (60) joined to a field emission device backlighting unit (50). The field emission device backlighting unit (50) includes a screen structure having a plurality of phosphor elements (33R, 33G, 33B) separated by a black matrix (39). The black matrix includes a metallic chrome layer. Spacers (15) separate the cathode (7) from the anode (4).

### FIELD OF THE INVENTION

The invention relates to liquid crystal display comprising a liquid crystal display front end component and a field emission device backlighting unit. The field emission device backlighting unit includes an anode with a screen structure having a black matrix formed with a metallic chrome layer and a method for making the same.

### BACKGROUND OF THE INVENTION

Liquid crystal displays (LCDs) are in general light valves. Thus, to create an image they must be illuminated. The elementary picture areas (pixels, sub-pixels) are created by small area, electronically addressable, light shutters. In conventional LCD displays, color is generated by white light illumination and color filtering of the individual sub-pixel light transmissions that correspond to the individual Red, Green, and Blue sub-images. More advanced LCD displays provide programmability of the backlight to allow motion blur elimination through scrolling of individual pulsed lights. For example, scrolling can be achieved by arranging a number of cold cathode fluorescent lamps such as the LCD display in U.S. Pat. No. 7,093,970 (having approximately 10 bulbs per display) in a manner such that the long axis of the lamps is along the horizontal axis of the display and the individual lamps are activated in approximate synchronism with the vertically progressive addressing of the LCD displays. Alternatively, hot filament fluorescent bulbs can be employed and can likewise be scrolled, with the individual bulbs progressively turning on and off in a top-to-bottom, cyclic manner, whereby the scrolling can reduce motion artifacts. The backlighting lamps are positioned before a diffuser. The LCD display can include a glass plate supporting a color filter and polarizer.

A concern for LCD manufacturers is the black levels of the display. Lamps tend to illuminate light over large screen areas, and as such, contrast enhancing features are needed to prevent light leakage through LCD pixels areas which are remote to the intended activated LCD pixels.

As such, a need exist for LCD displays that have intelligent backlighting and have superior contrast enhancing features.

### SUMMARY OF THE INVENTION

The invention relates to a liquid crystal display comprising a liquid crystal display front end component joined to a field emission device backlighting unit. The field emission device backlighting unit includes a screen structure having a plurality of phosphor elements separated by a black matrix. The black matrix includes a metallic chrome layer.

### BRIEF DESCRIPTION OF THE DRAWINGS

The invention will now be described by way of example with reference to the accompanying drawings.

FIG. 1 is a sectional view of a liquid crystal display including a liquid crystal display front end component and a field emission device backlighting unit according to the invention.

FIG. 2 is a plan view of a screen structure in the field emission device backlighting unit of FIG. 1.

FIG. 3 is a sectional view of the field emission device backlighting unit of FIG. 1.

FIG. 4 is a flow chart showing a method of forming a black matrix on the screen structure of FIG. 2.

### DETAILED DESCRIPTION OF THE INVENTION

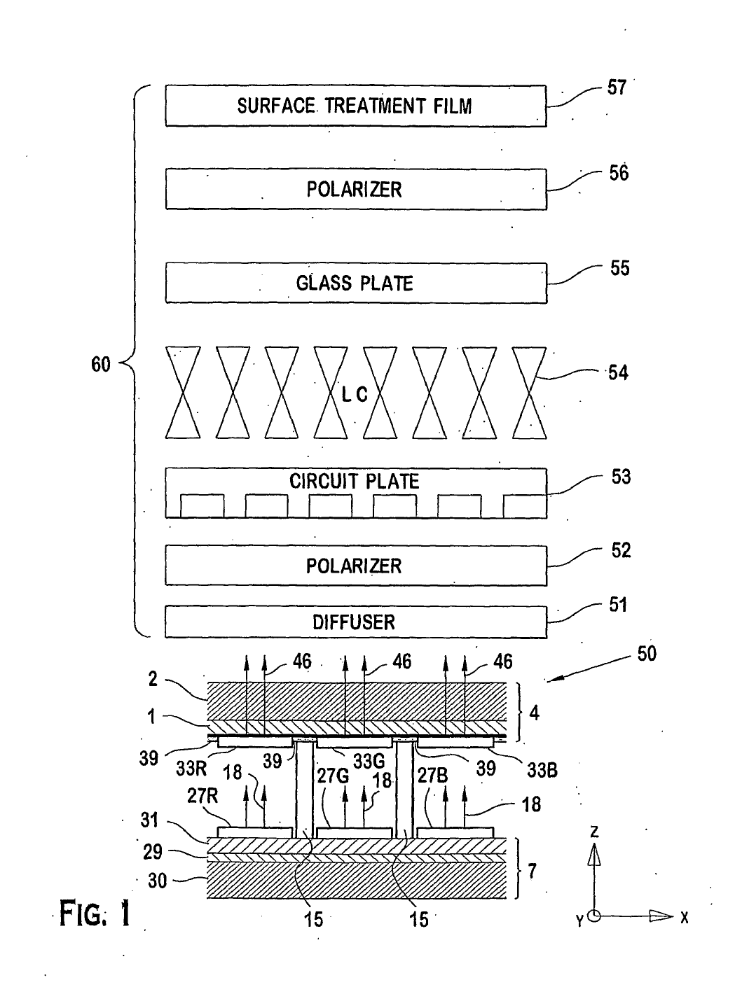

FIG. 1 shows a liquid crystal display according to the invention. As shown in FIG. 1, the liquid crystal display includes a liquid crystal display front end component 60 and a field emission device backlighting unit 50. In the illustrated embodiment, the field emission device backlighting unit 50 is joined to the liquid crystal display front end component 60 to provide backlighting for the liquid crystal display. The field emission device backlighting unit 50, however, can also be used as a direct display device, which does not include the liquid crystal display front end component 60.

As shown in FIG. 1, the liquid crystal display front end component 60 consists of a diffuser 51, a polarizer 52, a circuit plate 53, a liquid crystal (LC) 54, a glass plate 55, a second polarizer 56 and a surface treatment film 57. The diffuser 51 and the polarizer 52 may include brightness enhancement elements such as a VIKUITI™ optical film made by 3M, which increases the brightness of the liquid crystal display by recycling otherwise unused light and optimizing the angle of light incident on the LC 54. Because the configuration and operation of the diffuser 51, the polarizer 52, the circuit plate 53, the LC 54, the glass plate 55, the second polarizer 56 and the surface treatment film 57 are known in the art, further description thereof will not be provided herein.

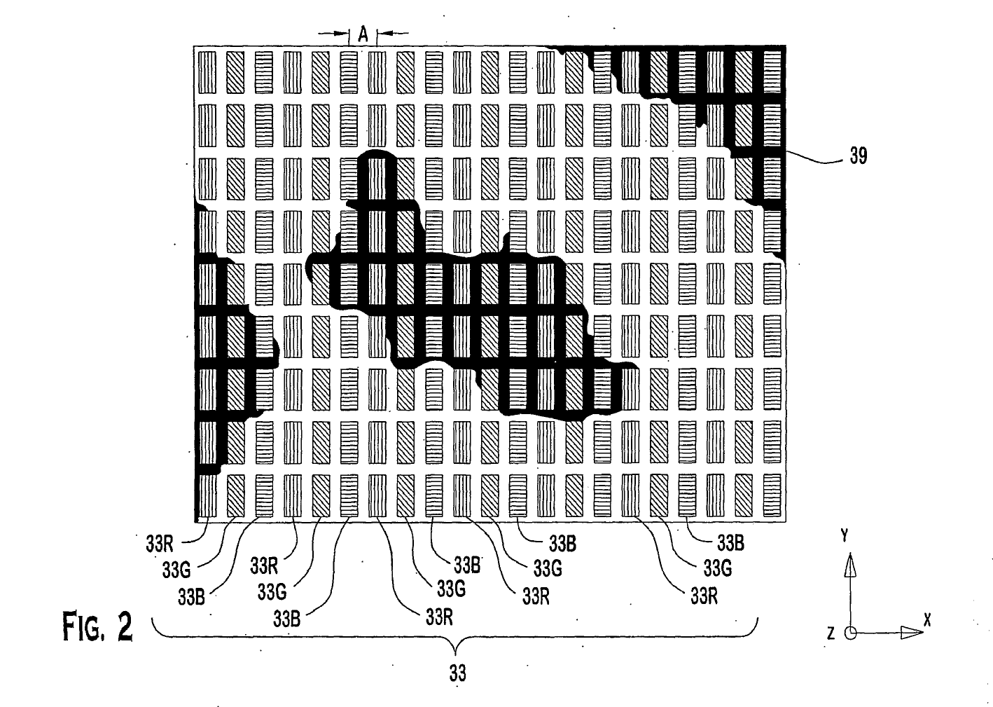

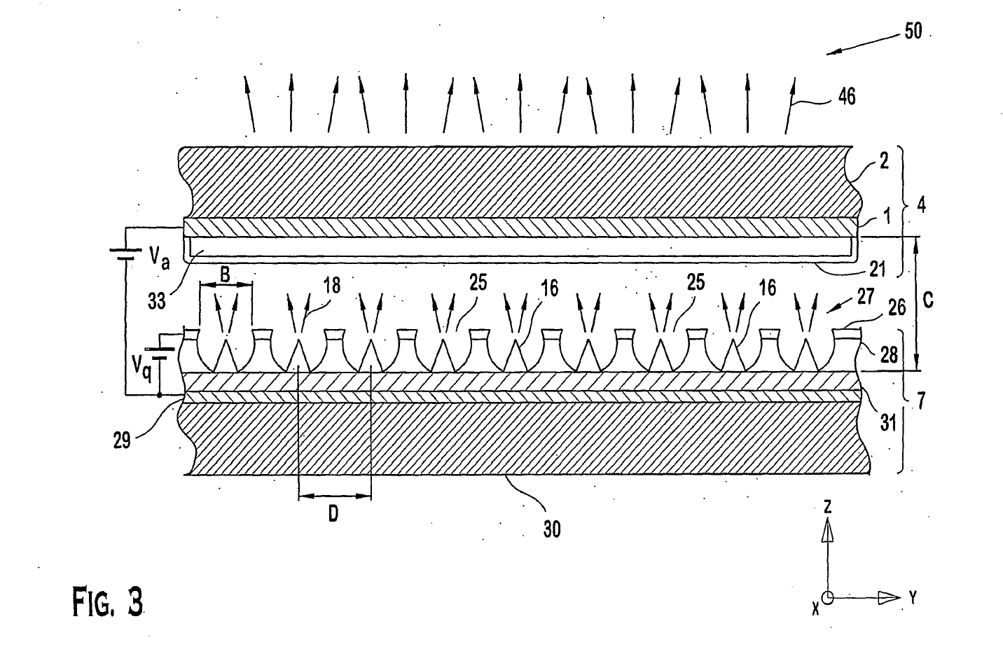

As shown in FIG. 1, the field emission device backlighting unit 50 consists of a cathode 7 and an anode 4. As shown in FIG. 3, the anode 4 includes a glass substrate 2 having a transparent conductor 1 deposited thereon. The transparent conductor 1 may be, for example, indium tin oxide. A black matrix 39 and phosphor elements 33 are applied to the transparent conductor 1 to form a screen structure, as shown in FIG. 2. Essentially, the screen structure consists of a plurality of phosphor elements 33 separated by a black matrix 39.

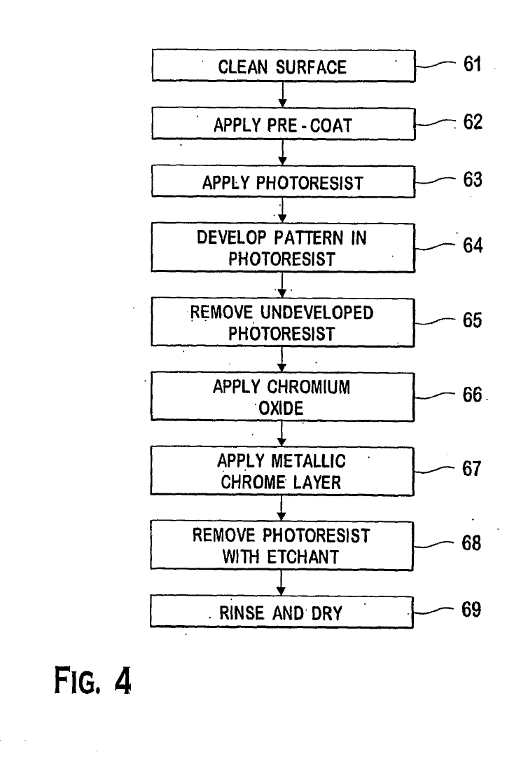

FIG. 4 shows a method of applying the black matrix 39 to the glass substrate 2. As shown at step 61, a surface of the glass substrate 2 is cleaned. The surface may be cleaned, for example, by washing the surface with a caustic solution, rinsing the surface with water, etching the surface with buffered hydrofluoric acid, and rinsing the surface again with water. At step 62, a pre-coat is applied to the surface of the glass substrate 2. The pre-coat may be, for example, a polyvinyl alcohol solution. At step 63, photoresist is applied to the glass substrate 2. At step 64, the photoresist is exposed to visible light to develop a pattern in the photoresist. A mask can be used in step 64. At step 65, undeveloped photoresist is then removed. The undeveloped photoresist may be removed, for example, by rinsing the surface of the glass substrate 2 with a solvent, such as water.

At step 66, a film of chromium oxide or other contrast enhancing material is formed over the surface of the glass substrate 2. The film may be formed, for example, by exposing the surface of the glass substrate 2 to a plasma of chromium oxide ions by a sputtering process. If chromium oxide is applied, then at step 67, a metallic chrome layer is applied to the film of chromium oxide. The metallic chrome layer may be formed on the chromium oxide, for example, by turning off oxygen in later stages of the sputtering process. At step 68, the photoresist is removed with an etchant. If a metallic chrome layer is applied, then concentration of the etchant may be about 5 times more than the concentration of the etchant used in a typical cathode ray tube etching process and may be heated, for example, to a temperature of 200 degrees Fahrenheit. Immersion time in the etchant may be about 2-4 minutes. At step 69, the surface of the glass substrate 2 is rinsed to remove any remaining loose material and is subsequently dried. The surface of the glass substrate 2 may be rinsed, for example, with high pressured water.

The phosphor elements 33 may be applied to the glass substrate 2 either before or after the black matrix 39 is applied thereto. As shown in FIG. 2, the phosphor elements 33 consist of red phosphor elements 33R, green phosphor elements 33G, and blue phosphor elements 33B. The red phosphor elements 33R, the green phosphor elements 33G, and the blue phosphor elements 33B are formed in columns and rows. Each column has only one phosphor element color and the phosphor element colors cycle along each of the rows. The phosphor elements 33 are arranged at a pitch A of about 1-5 millimeters. The phosphor elements 33 may be formed from low voltage phosphor materials, cathode ray tube phosphor materials, or non-water compatible phosphor. In the 10-15 kilovolt operating range, cathode ray tube phosphor materials are the most suitable.

As shown in FIG. 3, a substantially thin reflective metal film 21 may be applied over the phosphor elements 33 and/or the black matrix 39. The reflective metal film 21 serves to enhance the brightness of the field emission device backlighting unit 50 by reflecting light emitted toward the cathode 7 away from the cathode 7.

As shown in FIG. 1, spacers 15 are arranged between the phosphor elements 33 and extend from the black matrix 39. In the illustrated embodiment, the spacers 15 have a uniform height and are disposed between a plurality of the phosphor elements 33. The spacers 15 may be formed, for example, from a ceramic material. The spacers 15 may be bonded to the black matrix 39, for example, with gold. Because the spacers 15 are bonded to the metallic chrome layer of the black matrix 39, adhesion to the black matrix 39 is optimized. Although graphite has excellent contrast enhancing character, graphite is less preferred than metallic chrome layer, because graphite has poorer strength and adhesion properties; as such, the spacers are more susceptible to becoming loose or damaged. If the spacers become loose or damaged, the integrity of the spacing and/or alignment between the cathode and the anode may be jeopardized.

As shown in FIG. 3, the cathode 7 includes a dielectric material 28, a dielectric support 31, a back plate 29 and a back plate support structure 30. The dielectric material 28 has a plurality of emitter cells 27. As shown in FIG. 2, the emitter cells 27 consist of red emitter cells 27R, green emitter cells 27G, and blue emitter cells 27B arranged in rows. The cathode 7 may comprise between about 10-1,000 individually programmable rows and columns depending on the desired use of the field emission device backlighting unit 50. As shown in FIG. 3, each of the emitter cells 27 contains a plurality of electron emitters 16. The electron emitters 16 are arranged in an array and have emitter apertures 25. In the illustrated embodiment, the electron emitters 16 are conical microtips emitters, however it will be appreciated by those skilled in the art that other types of electron emitters may be used, such as carbon nanotubes emitters, which can be effective in field emission device backlighting unit 50 operating at an anode potential of 10 kilovolt or greater in the pixel resolution range of 1 millimeter and larger. The electron emitters 16 have a pitch D of about 15-30 microns. The emitter apertures 25 have an opening dimension B of about 10 microns. Each of the electron emitters 16 is associated with a gate 26. The gate 26 may be supported on the dielectric material 28. The FED backlight component can have lower resolution than the front-end LCD (i.e. the particular activation of a cell of the backlight can provide the selected color light for a plurality of LCD pixels).

As shown in FIG. 3, the cathode 7 is spaced from the anode 4 a distance C of about 1-5 millimeters. The cathode 7 is sealed to the anode 4 such that a plurality of the emitter cells 27 are aligned with each of the phosphor elements 33. The distance C is maintained by the spacers 15, which extend between the cathode 7 and the anode 4, as shown in FIG. 1. In the illustrated embodiment, each of the red emitter cells 27R is aligned with the red phosphor elements 33R, each of the green emitter cells 27G is aligned with the green phosphor elements 33G, and each of the blue emitter cells 27B is aligned with the blue phosphor elements 33R.

The operation of the field emission device backlighting unit 50 will now be described. A power source (not shown) applies a potential Va to the anode 4. The power source (not shown) may be, for example, a DC power supply that operates in the 10-20 kilovolt range. A gate potential Vq is applied to the desired gates 26. Due to an electric field created in the cathode 7, the electron emitters 16 emit electrons 18. The electrons 18 travel through the emitter apertures 25 toward the anode 4. The electrons 18 strike the corresponding phosphor elements 33 on the anode 4 thereby causing photons 46 to be emitted. The photons are directed toward the diffuser 51 of the liquid crystal display front end component 60. The photons 46 are diffused such that white, green, red, and/or blue light pass through pixels of the liquid crystal display when the appropriate red, green, and/or blue phosphor elements 33R, 33G, 33B are activated.

The field emission device backlighting unit 50 may be programmable such that the field emission device backlighting unit 50 can selectively provide specific colored light to specific pixels of the liquid crystal display. When the field emission device backlighting unit 50 is programmable, the liquid crystal display can achieve optimal black levels, wide dynamic range, blur-free motion rendition, and a large color gamut. In the illustrated embodiment, the field emission device backlighting unit 50 is operated in a color sequential mode, thus no color filters are required in the liquid crystal display front end component 60; however, another embodiment of the invention can include color filters which could provide an opportunity for narrower color wavelength ranges.

In the field emission device backlighting unit 50 according to the present invention, the black matrix 39 preferably comprises a film of chromium oxide and a metallic chromium layer. Because the chromium oxide and the metallic chromium layer are applied by sputtering, the black matrix is easy and inexpensive to manufacture. Additionally, as mentioned above, because the spacers 15 are bonded to the metallic chrome layer of the black matrix 39, which has good strength and adhesion properties, adhesion of the spacers 15 to the black matrix 39 is optimized. As a result, the precise spacing and/or alignment of the cathode 7 with respect to the anode 4 by the spacers 15 is ensured.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. A liquid crystal display, comprising:
a liquid crystal display front end component; and
a field emission device backlighting unit joined to the liquid crystal display front end component, the field emission device backlighting unit including a screen structure having a plurality of phosphor elements separated by a black matrix.

2. The liquid crystal display of claim 1, wherein the black matrix includes a metallic chrome layer.

3. The liquid crystal display of claim 2, wherein the black matrix includes a film of chromium oxide.

4. The liquid crystal display of claim 3, wherein the field emission device includes an anode and a cathode, the screen structure being formed on a surface of the anode.

5. The liquid crystal display of claim 4, wherein the anode is spaced from the cathode by spacers extending there between.

6. The liquid crystal display of claim 5, wherein the spacers are adhered to the metallic chrome layer.

7. The liquid crystal display of claim 4, wherein the cathode includes emitter cells, the emitter cells being aligned with the phosphor elements.

8. The liquid crystal display of claim 1, wherein the cathode includes emitter cells, the emitter cells being aligned with the phosphor elements.

9. The liquid crystal display of claim 1, wherein the field emission device backlighting unit is lower resolution than the liquid crystal front-end component.

10. The liquid crystal display of claim 2, wherein the field emission device backlighting unit is lower resolution than the liquid crystal front-end component.

11. A field emission display, comprising:
a screen structure having a plurality of phosphor elements separated by a black matrix, the black matrix including a metallic chrome layer.

12. The field emission display of claim 11, wherein the black matrix includes a film of chromium oxide.

13. The field emission display of claim 12, further comprising an anode and a cathode, the screen structure being formed on a surface of the anode.

14. The field emission display of claim 13, wherein the anode is spaced from the cathode by spacers extending there between.

15. The field emission display of claim 14, wherein the spacers are adhered to the metallic chrome layer.

16. The field emission display of claim 15, wherein the cathode includes emitter cells the emitter cells being aligned with the phosphor elements.
